(19) United States
(12) Patent Application Publication
(10) Pub. No.: US 2026/0226199 A1
(43) Pub. Date: Aug. 6, 2026

(54) MANUFACTURE OF FLUOROPOLYMER LATEX BY DUAL SURFACTANTS

(71) Applicant: Arkema Inc., King of Prussia, PA (US)

(72) Inventors: Yuanqin LIU, King of Prussia, PA (US); Andrew P. KAHN, King of Prussia, PA (US); Caiping LIN, King of Prussia, PA (US)

(21) Appl. No.: 19/154,801

(22) PCT Filed: Feb. 6, 2024
(86) PCT No.: PCT/US2024/014538

§ 371 Date: Aug. 8, 2025

Related U.S. Application Data
(60) Provisional application No. 63/444,648, filed on Feb. 10, 2023.

(51) Int. Cl. C08F 2/30; C08F 2/26; C08F 214/22

(52) U.S. Cl. CPC C08F 2/30; C08F 2/26; C08F 214/22

(57) ABSTRACT

A process for preparing a fluoropolymer is disclosed the process comprises reacting fluoromonomer in the presence of at least one acrylic-glycol surfactant and at least one sulfur containing surfactant or mixtures thereof. Also disclosed is the polymer made by the process. Also disclosed is a polymer composition comprising at least one sulfur containing surfactant and at least on acrylic-glycol surfactant and at least one fluoropolymer.

### FIELD OF THE INVENTION

This invention describes a fluoropolymer latex and a method for making a fluoropolymer latex. The particle size of the fluoropolymer is controlled by the present method.

### BACKGROUND OF THE INVENTION

Processes for making fluoropolymers by an emulsion process commonly use surfactants to stabilize the fluoropolymer latex during the polymerization reaction. See, for example, US patents: U.S. Pat. Nos. 7,122,610, 8,080,621, 8,124,699, 8,697,822, and 9,068,071. Yet none of these teach that by utilizing a dual surfactant system in the emulsion polymerization process that the particle size can be controlled based on the weight ratio of surfactants.

The prior art does not disclose a method of controlling the average particle size of a fluoropolymer latex using a dual surfactants system in an emulsion polymerization. No teachings have been found that utilize the two families of surfactants as used in the present invention in an emulsion polymerization of a fluoropolymer to control the particle size of the fluoropolymer.

This work is the first to present a method to control the fluoropolymer latex particle size of PVDF latex from the polymerization process. Applicants have found that by varying the weight ratio of the two surfactants (Sulfur containing surfactant and Acrylic-glycol surfactant), in the emulsion polymerization process the fluoropolymer particle size in the latex can be adjusted. The fluoropolymer particle size in the latex exhibits a linear correlation with the surfactant ratio used in the emulsion polymerization. This correlation can be used to target particle size in the PVDF latex preparation.

### BRIEF DESCRIPTION OF THE FIGURES

FIG. 1 Show linear relationship between surfactant ratio and fluoropolymer particle size in the latex.

### SUMMARY OF THE INVENTION

This invention describes a fluoropolymer latex and a method to make the fluoropolymer latex utilizing at least two surfactants in an emulsion polymerization process. The utilization of the two surfactants in the emulsion polymerization process can control average particle size of the fluoropolymer in the resulting latex. Fluoropolymer latex is prepared by emulsion polymerization using fluoromonomer(s), two surfactants, and persulfate initiator. It was surprisingly found that the fluoropolymer particle size in the latex can be adjusted by varying the weight ratio of the two surfactants.

The method comprises:
a) contacting an aqueous mixture comprising a first surfactant, a second surfactant and a monomer feed comprising one or more fluoromonomers, optional additives (such as chain transfer agent, buffer, etc) with a radical initiator;
b) polymerizing the one or more fluoromonomers, thereby forming a fluoropolymer latex.

The first surfactant comprises a sulfur containing surfactant and the second surfactant comprises an alkyl-glycol containing surfactant.

### Embodiments of the Invention

Embodiment 1 of the invention is a process for preparing a fluoropolymer, said process comprising:
a) providing in a reaction vessel, an aqueous reaction medium, at least one fluoromonomer, optionally a chain transfer agent,
   i) one acrylic-glycol surfactant having at least one segment selected from polyethylene glycol segment, polypropylene glycol segment, and/or polytetramethylene glycol segment, with from 2 to 200 repeating units in a segment, and
   ii) sulfur containing surfactant wherein the sulfur containing surfactant is non-fluorinated and comprises at least one of an alkylsulfonate, an alkyl sulfate surfactant, or mixtures thereof,
b) adding at least one radical initiator to said reaction vessel, and
c) initiating an emulsion polymerization of said fluoromonomer, to provide a fluoropolymer latex,
wherein the total amount of surfactant(s) in the process is at least 110 ppm based on the total weight of the fluoromonomer(s) fed to the polymerization reaction.

Embodiment 2: The process of Embodiment 1, wherein the weight ratio of the sulfur containing surfactant to the acrylic-glycol containing surfactant is between 0.1 and 500 (weight by weight).

Embodiment 3: The process of Embodiment 1, wherein the weight ratio of the sulfur containing surfactant to the acrylic-glycol containing surfactant is between 0.4 and 150 (weight. by weight).

Embodiment 4: The process of any one of the above Embodiments, wherein the amount of the sulfur containing surfactant in the process is from 100 ppm to less than 5000 ppm based on total fluoromonomer(s) fed to the emulsion polymerization reaction.

Embodiment 5: The process of any one of the above Embodiments, wherein the amount of the sulfur containing surfactant in the process is from 200 ppm to 3500 ppm based on total fluoromonomer(s) fed to the emulsion polymerization reaction.

Embodiment 6: The process of any one of the above Embodiments, wherein the amount of the amount of the acrylic-glycol surfactant in the process is from about 10 ppm to about 1000 ppm based on total fluoromonomer(s) fed to the emulsion polymerization reaction.

Embodiment 7: The process of any one of Embodiments 1 to 5, wherein the amount of the acrylic-glycol surfactant in the process is from about 10 ppm to about 600 ppm based on total fluoromonomer(s) fed to the emulsion polymerization reaction.

Embodiment 8: The process of any one of Embodiments 1 to 7, wherein the volume average particle size of the fluoropolymer is in the range of 110 nm to 350 nm.

Embodiment 9: The process of any one of Embodiments 1 to 9, wherein the total amount of surfactant present in the process is at least 110 ppm and up to 6000 ppm, based on the total weight of the fluoromonomer(s) fed to the emulsion polymerization reaction.

Embodiment 10: The process of any one of Embodiments 1 to 9, wherein the total amount of surfactant present in the process is between of 200 ppm to 5000 ppm, based on the total weight of the fluoromonomer(s) fed to the emulsion polymerization reaction.

Embodiment 11: The process of any one of Embodiments 1 to 10, wherein the acrylic-glycol surfactant(s) has from 2 to 100 repeating glycol units, preferably ethylene glycol or propylene glycol.

Embodiment 12: The process of any one of Embodiments 1 to 11, wherein the acrylic-glycol containing surfactants are selected from the group consisting of, polyethylene glycol acrylate (PEGA), polyethylene glycol methacrylate (PEGMA), polypropylene glycol acrylate (PPGA), polypropylene glycol methacrylate (PPGMA), polypropylene glycol polyethylene glycol acrylate, polypropylene glycol polyethylene glycol methacrylate, and polypropylene glycol di-methacrylate.

Embodiment 13: The process of any one of Embodiments 1 to 11, wherein the surfactant(s) containing acrylic-glycol comprises polypropylene glycol methacrylate (PPGMA).

Embodiment 14: The process of any one of Embodiments 1 to 13, wherein alkyl group on the sulfur containing surfactant comprises a C6-C18 alkyl group.

Embodiment 15: The process of any one of Embodiments 1 to 13, wherein the sulfur containing surfactant comprises a non-fluorinated alkylsulfonate selected from the group consisting of octylsulfonates, octyldisulfonates, decylsulfonates, decyldisulfonates, dodecylsulfonates, dodecyldisulfonates, and combinations thereof.

Embodiment 16: The process of any one of Embodiments 1 to 13, wherein the sulfur containing surfactant comprises at least one of an octylsulfonate, an octyldisulfonate or a decylsulfonate.

Embodiment 18: The process of any one of Embodiments 1 to 13, wherein the sulfur containing surfactant comprises at least one of sodium lauryl sulfate, potassium lauryl sulfate, ammonium lauryl sulfate, lithium lauryl sulfate, sodium laureth sulfate, sodium octyl sulfate, potassium octyl sulfate, ammonium octyl sulfate, lithium octyl sulfate and combination thereof.

Embodiment 19: The process of any one of Embodiments 1 to 10, wherein the acrylic-glycol surfactant comprises polypropylene glycol methacrylate (PPGMA) and the sulfur containing surfactant comprises an octyl sulfonate.

Embodiment 20: The process of any one of Embodiments 1 to 19, wherein the radical initiator comprises a persulfate salt.

Embodiment 21: The process of any one of Embodiments 1 to 20, wherein said at least one fluoromonomer is selected from the group consisting of vinylidene fluoride, hexafluoropropene, tetrafluoroethylene, trifluoroethylene, chlorotrifluoroethylene, vinyl fluoride, and combinations thereof.

Embodiment 22: The process of any one of Embodiments 1 to 21, wherein at least 65 wt % of the fluoromonomer added comprises vinylidene fluoride monomer.

Embodiment 23: The process of any one of Embodiments 1 to 20, wherein the fluoromonomer consists of vinylidene fluoride monomer.

Embodiment 24: The process of any one of Embodiments 1 to 22, wherein said fluoropolymer is a vinylidene fluoride copolymer comprising at least one comonomer selected from the group consisting of tetrafluoroethylene, trifluoroethylene, hexafluoropropene, chlorotrifluoroethylene, vinyl fluoride, and combinations thereof.

Embodiment 25: The process of Embodiment 21, wherein said fluoromonomer consists of vinylidene fluoride and hexafluoropropene.

Embodiment 26: An fluoropolymer composition comprising:
a) at least one sulfur containing surfactant and at least on acrylic-glycol surfactant, and
b) at least one fluoropolymer.

Embodiment 27: The fluoropolymer latex composition of Embodiment 26, wherein the acrylic-glycol surfactant(s) has from 2 to 100 repeating glycol units, preferably ethylene glycol or propylene glycol.

Embodiment 28: The fluoropolymer latex composition of Embodiment 26, wherein the acrylic-glycol containing surfactants are selected from the group consisting of, polyethylene glycol acrylate (PEGA), polyethylene glycol methacrylate (PEGMA), polypropylene glycol acrylate (PPGA), polypropylene glycol methacrylate (PPGMA), polypropylene glycol polyethylene glycol acrylate, polypropylene glycol polyethylene glycol methacrylate, and polypropylene glycol di-methacrylate.

Embodiment 29: The fluoropolymer latex composition of Embodiment 26, wherein the surfactant(s) containing acrylic-glycol comprises polypropylene glycol methacrylate (PPGMA).

Embodiment 30: The fluoropolymer latex composition of any one of Embodiments 26 to 29, wherein the sulfur containing surfactant comprises a C6-C18 alkyl group.

Embodiment 31: The fluoropolymer latex composition of any one of Embodiments 26 to 29, wherein the sulfur containing surfactant comprises a non-fluorinated alkylsulfonate selected from the group consisting of octylsulfonates, octyldisulfonates, decylsulfonates, decyldisulfonates, dodecylsulfonates, dodecyldisulfonates, and combinations thereof.

Embodiment 32: The fluoropolymer latex composition of any one of Embodiments 26 to 29, wherein the sulfur containing surfactant comprises at least one of an octylsulfonate, an octyldisulfonate or a decylsulfonate.

Embodiment 33: The fluoropolymer latex composition of any one of Embodiments 26 to 29, wherein the sulfur containing surfactant comprises at least one of sodium lauryl sulfate, potassium lauryl sulfate, ammonium lauryl sulfate, lithium lauryl sulfate, sodium laureth sulfate, sodium octyl sulfate, potassium octyl sulfate, ammonium octyl sulfate, lithium octyl sulfate and combination thereof.

Embodiment 34: The fluoropolymer latex composition of Embodiment 26, wherein the acrylic-glycol surfactant comprises polypropylene glycol methacrylate (PPGMA) and the sulfur containing surfactant comprises an octyl sulfonate.

Embodiment 35: The fluoropolymer latex composition of any one of Embodiments 26 to 34, wherein the fluoropolymer comprises fluoromonomer units said selected from the group consisting of vinylidene fluoride, hexafluoropropene, tetrafluoroethylene, trifluoroethylene, chlorotrifluoroethylene, vinyl fluoride, and combinations thereof.

Embodiment 36: The fluoropolymer latex composition of any one of Embodiments 26 to 34, wherein the fluoropolymer is polyvinylidene fluoride comprising at least 65 wt % of vinylidene fluoride.

Embodiment 37: The fluoropolymer latex composition of any one of Embodiments 26 to 34, wherein the fluoropolymer is a polyvinylidene fluoride homopolymer.

Embodiment 38: The fluoropolymer latex composition of any one of Embodiments 26 to 34, wherein the fluoropolymer is polyvinylidene fluoride copolymer comprising at least 65 wt % of vinylidene fluoride and at least one comonomer selected from the group consisting of tetrafluoroethylene, trifluoroethylene, hexafluoropropene, chlorotrifluoroethylene, vinyl fluoride, and combinations thereof.

Embodiment 39: The fluoropolymer latex composition of any one of Embodiments 26 to 34, wherein the fluoropolymer is a polyvinylidene fluoride/hexafluoropropene copolymer comprising at least 65 wt % of vinylidene fluoride.

### DETAILED DESCRIPTION OF THE INVENTION

The references cited in this application are incorporated herein by reference.

Percentages, as used herein are weight percentages (wt %), unless noted otherwise.

Melt viscosity are according to ASTM D3835 by a capillary rheometry at 230° C. and 100 sec-1.

Solids means the matter that remains after drying of the fluoropolymer latex. The solids of the fluoropolymer latex were measured by means of gravimetry method using a HG63 moisture analyzer from Mettler Toledo.

The term “fluoropolymer” refers to polymers and copolymers (including polymers having two or more different monomers, including for example terpolymers) containing at least 50 mole percent of fluoromonomer units. The polymers may be homogeneous, heterogeneous, or random, and may have a gradient distribution of co-monomer units.

The term “fluoropolymer latex” refers to the aqueous dispersion of fluoropolymer obtained from the emulsion polymerization of fluoromonomers.

“Copolymer” is used to mean a polymer having two or more different monomer units, including terpolymers and higher degree polymers. “Polymer” is used to mean both homopolymer and copolymers.

“PVDF” means polyvinylidene fluoride, this includes both homopolymer and copolymers unless otherwise noted.

Ethylenic means the monomer has a polymerizable carbon-carbon double bond.

The invention provides a method, utilizing at least two surfactants in an emulsion polymerization, to prepare fluoropolymers from fluoromonomers. The fluoropolymers are prepared in an aqueous mixture that comprises fluoromonomer(s), surfactant 1 (sulfur containing surfactant), surfactant 2 (acrylic-glycol containing surfactant), optional chain transfer agent, optionally buffer(s), and initiator. The surfactants are non-fluorinated. Optionally, the polymerization of the invention may be performed in the presence of chain transfer agents, buffering agents to maintain a desired pH range during the polymerization, and antifoulants to reduce or eliminate adhesion of the polymer to the inside surfaces of the polymerization vessel. The resultant product from the emulsion polymerization is a fluoropolymer latex.

Applicants have surprisingly found that particle size of the fluoropolymer in the latex is controlled by controlling the weight ratio of the first surfactant to the second surfactant in the emulsion polymerization of fluoromonomer. Generally, the fluoropolymer particle size in the latex can be adjusted in the range of 100 nm-400 nm.

### Polymerization Process

The general emulsion polymerization procedure may be followed: to a reactor is initially added deionized water, surfactant 1 and surfactant 2, optionally a chain-transfer agent, optionally an antifoulant and/or optionally buffer, followed by deoxygenation (removal of oxygen). The water generally is added to the reactor before bringing the reactor to the desired starting temperature, but the other materials may be added before or after bringing the reactor to temperature. No oily phase, such as fluoroform, is utilized. The reactor may be a pressurized polymerization reactor equipped with a stirrer and heat control means. The stirring may be constant, or may be adjusted to optimize process conditions during the polymerization. After the reactor reaches the desired temperature, a certain amount of monomer and/or co monomer is added to the reactor. The ratio of the monomer and co monomer can be selected. At least one radical initiator is added to start and maintain the polymerization. The initiator solution and optional buffer solution and optional chain transfer agents are fed to the reactor with a suitable flow rate. Additional monomer may be optionally added to replenish monomer that is consumed, and the other materials may be optionally added during the course of the polymerization to maintain the reaction and control the final product properties. After reaching the desired total monomer fed, the feed of monomer can be stopped. The unreacted monomers can be vented and the prepared fluoropolymer latex can be collected through a drain port or by other collection means. The fluoropolymer latex can be kept in the aqueous media for subsequent application or use. Alternatively, can be converted into a dry form.

The pressure used for polymerization may be selected from a wide range of pressures, from about 280 to about 20,000 kPa, depending on the capabilities of the reaction equipment, the initiator system chosen, and the monomer composition used. The polymerization pressure is typically from about 2,000 to about 11,000 kPa, and most typically from about 2,750 to about 9,000 kPa. The polymerization temperature may vary from about 20° C. to about 160° C., depending on the initiator system chosen, and is typically from about 35° C. to about 130° C., and most typically from about 65° C. to about 100° C.

### Fluoropolymer

The term “fluoropolymer” as used for purposes of this invention means a polymeric material comprising at least 65 wt % of vinylidene fluoride units, with the remainder of the units being one or more fluoromonomers. The fluoropolymer may consist essentially of vinylidene fluoride and optionally other fluoromonomer units, or it may comprise other comonomer units as well.

The fluoropolymers may be homopolymers, copolymers, terpolymers or higher degree polymers (more than three different monomers). The fluoropolymers can be thermoplastic, where “thermoplastic” means the ability to be formed into shapes by the application of heat and (typically) pressure, such as is done in molding and extrusion processes. Exemplary polymers made by the methods of the invention include polyvinylidene fluoride homopolymer, copolymers, terpolymers and higher polymers having a vinylidene fluoride content of at least 65 wt %, and typically at least 75 wt %. Specific fluoropolymers according to the invention include for example copolymers of vinylidene fluoride with hexafluoropropylene, tetrafluoroethylene, or trifluoroethylene, and terpolymers of vinylidene fluoride with tetrafluoroethylene and hexafluoropropylene or with tetrafluoroethylene and trifluoroethylene. Other copolymers and terpolymers may contain fluoromonomers other than those listed above, in combination with vinylidene fluoride.

Fluoromonomers are used to have the fluoropolymer of the present invention. The term “fluoromonomer” as used according to the invention means a fluorinated and ethylenically unsaturated monomer capable of taking part in a free radical polymerization reaction. Suitable fluoromonomers for use according to the invention include at least one fluorine atom, and may for example incorporate a fluoroalkyl group, a fluoroalkoxy group, or a vinylic fluorine atom.

Suitable exemplary fluoromonomers for use according to the invention, in addition to vinylidene fluoride, can be any one or more of vinyl fluoride, trifluoroethylene, tetrafluoroethylene (TFE), hexafluoropropylene (HFP), partly or fully fluorinated alpha-olefins such as 3,3,3-trifluoro-1-propene, 1,2,3,3,3-pentafluoropropene, 3,3,3,4,4-pentafluoro-1-butene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro (1,3-dioxole) and perfluoro (2,2-dimethyl-1,3-dioxole), and partly or fully fluorinated allylic monomers based on, for example, 2-hydroxyethyl allyl ether or 3-allyloxypropanediol.

The fluoropolymer of the present invention may comprise vinylidene fluoride polymer having at least 65 wt % VDF monomer units.

The copolymers can be composed of from at least about 65 and up to 99 wt % vinylidene fluoride, and correspondingly from 1 to 35 percent of a comonomer such as tetrafluoroethylene, hexafluoropropene and trifluoroethylene. The copolymer can be a copolymer of vinylidene fluoride and hexafluoropropene.

### Surfactants

This invention uses at least two classes of surfactants, surfactant 1 and surfactant 2.

The first class of surfactants (surfactant 1) are types of molecules that have both hydrophobic and hydrophilic, portions, which allows it to stabilize and disperse hydrophobic molecules and aggregates of hydrophobic molecules in aqueous media. Examples of surfactants include alkyl or (alk)aryl groups linked to sulphonate groups or sulfate groups. A preferred group of the first-class of surfactants for the fluoropolymer latex of the present invention includes alkyl sulfate and alkyl sulfonate surfactants (“sulfur containing surfactants”). The term “alkyl sulfate surfactants” or “alkyl sulfonate surfactants” means surfactants having alkyl hydrocarbon groups as their hydrophobic portion, preferably the alkyl hydrocarbon group comprises a C6 to C18 alkyl group. The alkyl hydrocarbon groups of these alkyl sulfate and alkyl sulfonate surfactants are functionalized with one or two sulfate and/or sulfonate groups, as their hydrophilic portion. The hydrocarbon group does not contain any fluorine. The hydrocarbon group comprises a C6 to C18 alkyl group. Preferred surfactants of the first class are in salt form preferably having the counter ion being an alkali metal (for example lithium, sodium, or potassium), an ammonium ion, or an alkyl-substituted ammonium ion.

Examples of alkyl sulfate surfactants include, but are not limited to, salts of C6 to C18 alkylsulfates. For example lauryl sulfate and octyl sulfate salts. Examples include but are not limited to sodium lauryl sulfate, potassium lauryl sulfate, ammonium lauryl sulfate, lithium lauryl sulfate, sodium laureth sulfate, sodium octyl sulfate, and mixtures thereof

Examples of alkyl sulfonate surfactants include, but are not limited to, salts of C6-C18 alkyl sulfonates, and salts of C6-C18 alkyl di-sulfonates, and mixtures thereof. Examples of typical counter ions for alkyl sulfonate surfactants include, but not limited sodium, potassium, lithium, ammonium or alkyl-substituted ammonium. For example salts of the C8-C12 alkyl sulfonates can be used such as, octylsulfonates, octyldisulfonates, decylsulfonates, decyldisulfonates, dodecylsulfonates, dodecyldisulfonates and combinations thereof can be used. By example, octylsulfonate can be sodium octylsulfonate, potassium octylsulfonate, ammonium octylsulfonate, alkyl-substituted ammonium octylsulfonate, lithium octylsulfonate.

The second class of surfactants (surfactant 2) suitable for use in this invention are non-fluorinated non-ionic acrylic-glycol surfactants (also referred to as acrylic-glycol surfactants) which contain a vinyl double bound, which is preferably an acrylate or methacrylate group connected to a polyglycol segment such as of polyethylene glycol (PEG), polypropylene glycol (PPG), polytetramethylene glycol (PTMG) or a combination of any of these polyglycol segments thereof, with the repeating glycol unit preferably between 3 to 100 repeat units, and more preferably 3 to 50 repeat units.

The acrylic-glycol surfactants used in this invention include, but are not limited to, polyethylene glycol acrylate (PEGA), polyethylene glycol methacrylate (PEGMA), polypropylene glycol acrylate (PPGA), and polypropylene glycol methacrylate (PPGMA), polypropylene glycol polyethylene glycol acrylate, polypropylene glycol polyethylene glycol methacrylate, polyethylene glycol di-methacrylate and polypropylene glycol di-methacrylate.

Preferably, the acrylic-glycol surfactants comprises polypropylene glycol methacrylate (PPGMA) or polypropylene glycol acrylate (PPGA).

A PPGMA and/or PPGA can be used with an octylsulfonate in the invention to control particle size.

The first class of surfactants can be used in an amount of at least 100 ppm, it can be used from about 100 ppm to less than 5000 ppm based on total fluoromonomer(s) fed to the polymerization reaction. Preferably, the first class of surfactants can be used in an amount from about 100 ppm to 4000 ppm based on total fluoromonomer(s) fed to the polymerization reaction and more preferably from 200 ppm to 3500 ppm based on total fluoromonomer(s) fed to the polymerization reaction. The second class of surfactants can be used in an amount of at least 10 ppm, it can be used from about 10 ppm to about 2000 ppm or more based on total fluoromonomer(s) fed to the polymerization reaction, preferably in an amount from 10 ppm to 1000 ppm based on total fluoromonomer(s) fed to the polymerization reaction and more preferably from 10 ppm to 800 ppm based on total fluoromonomer(s) fed to the polymerization reaction.

In the polymerization process, the surfactants of this invention could be added all upfront prior to polymerization, fed continuously during the polymerization, fed partly before and then during polymerization.

### Ratio of Surfactants

By adding more of the acrylic-glycol containing surfactant (surfactant 2) and less of the sulfur containing surfactant (surfactant 1), a smaller particle size is achieved (the smaller the weight ratio of the surfactants, the smaller the particle size of the fluoropolymer produced). The weight ratio (weight by weight) of the sulfur containing surfactant (SCS, surfactant 1) to the acrylic-glycol containing surfactant (AGS, surfactant 2) is from 0.1 to 500. The invention can be worked at a weight ratio of between 0.4 and 150.

It is envisioned that the two surfactants can be feed at different feed rates such that the weight ratio changes during the course of the polymerization resulting is a controlled distribution of particle size. Spikes at different average particle size may be obtained providing a multimodal particle size distribution that can be targeted using the weight ratio of the surfactants feed in the polymerization reaction.

### Initiator

The term “initiator” and the expressions “radical initiator” and “free radical initiator” refer to a chemical that is capable of providing a source of free radicals, either induced spontaneously, or by exposure to heat or light. The radical initiator may comprise a persulfate salt, such as sodium persulfate, potassium persulfate (KPS), lithium persulfate or ammonium persulfate. The amount of persulfate salt added to the reaction mixture (based upon the total weight of monomer(s) added to the reaction mixture) may, for example, be from about 0.005 to about 1.0 wt %. The term “radical” and the expression “free radical” refer to a chemical species that contains at least one unpaired electron. The radical initiator is added to the reaction mixture in an amount sufficient to initiate and maintain the polymerization reaction rate. The order of addition may vary according to the desired process and latex emulsion characteristics.

The radical initiator may comprise a redox system. “Redox system” is understood by one having ordinary skill in the art to mean a system comprising an oxidizing agent, a reducing agent and optionally, a promoter as an electron transfer medium. Oxidizing agents include, for example, persulfate salts, peroxides, and oxidizing metal salts such as, for example, ferric sulfate. Reducing agents include, for example, sodium formaldehyde sulfoxylate, sodium and potassium sulfite, ascorbic acid, bisulfite, metabisulfite, and reduced metal salts. The promoter is a component of the redox system which, in different oxidation states, is capable of reacting with both the oxidant and the reducing agent, thereby accelerating the overall reaction. Promoters include, for example, transition metal salts such as ferrous sulfate. In redox systems, the oxidizing agent and the reducing agent may be utilized in an amount from about 0.01 to about 0.5 wt % on total monomer added to the polymerization. The optional promoter may be utilized in an amount from about 0.005 to about 0.025 wt % based on total monomer(s) added to the polymerization. Redox systems are described, for example, in G. S. Misra and U. D. N. Bajpai, Prag. Polym. Sci., 1982, 8 (1-2), pp. 61-131.

### Chain Transfer Agent

Chain transfer agent may be used in the polymerization reaction. A chain-transfer agent may be added to the aqueous reaction mixture. Chain transfer agent may be added to a polymerization in a single portion at the beginning of the reaction, or incrementally throughout the reaction or continuously throughout the reaction. When used, the amount and mode of addition of chain-transfer agent depend on the activity of the particular chain-transfer agent employed, and on the desired molecular weight of the polymer product. The amount of chain-transfer agent added to the polymerization reaction can be up to 5 wt %, preferably 0.05 to about 3 wt %, more preferably from about 0.1 to about 2 wt % based on the total weight of fluoromonomer(s) added to the reaction mixture. Examples of chain transfer agents useful in the present invention include, but are not limited to oxygenated compounds such as alcohols (preferably having 3 to 10 carbons), carbonates, ketones, esters, and ethers may serve as chain-transfer agents such as acetone, ethylacetate, diethylether, methyl-ter-butyl ether, isopropyl alcohol; bis(alkyl) carbonates wherein the alkyl has from 1 to 9 carbon atoms, such as bis(ethyl) carbonate, bis(isobutyl)-carbonate; ethane, propane, and those described in US2018/0072829, low molecular weight (less than 20000 g/mol, preferably less than 10,000 g/mol) polymer chain transfer agents containing one or more different functional groups including but not limited to, polyacrylic acid, polylactic acid, poly phosphonic acid, polysulfonic acid, and polymaleic acid.

A paraffin antifoulant may be employed, if desired, although it is not preferred, and any long-chain, saturated, hydrocarbon wax or oil may be used. Reactor loadings of the paraffin may be from 0.01 wt % to 0.3 wt % based on weight of the total fluoromonomer(s) added to the polymerization.

### Buffering Agent:

The polymerization reaction mixture may optionally contain a buffering agent to maintain a controlled pH throughout the polymerization reaction. The pH is preferably controlled within the range of from about 3 to about 8, to minimize undesirable color development in the product.

Buffering agents may comprise an organic or inorganic acid or alkali metal salt thereof, or base or salt of such organic or inorganic acid, that has at least one pKa value and/or pKb value in the range of from about 4 to about 10, preferably from about 4.5 to about 9.5. Preferred buffering agents in the practice of the invention include, for example, phosphate buffers and acetate buffers. A “phosphate buffer” is a salt or salts of phosphoric acid. An “acetate buffer” is a salt of acetic acid, for example, sodium acetate trihydrate (SAT).

### Product

The emulsion polymerization results in a fluoropolymer latex generally having a solids of 10 to 60 wt %, preferably 20 to 50 wt %.

The product of the emulsion polymerization is a fluoropolymer latex that can be used in that form, optionally after filtration of solid byproducts such as coagulated polymer from the polymerization process. For use in latex form, the fluoropolymer latex may be optionally stabilized by the addition of an additional surfactant, ionic surfactant or nonionic surfactant, either the same as or different from surfactants used in the emulsion polymerization. Alternatively the fluoropolymer latex may be coagulated to isolate the solid fluoropolymer, which may then be washed and dried. Coagulation methods are well-known in the art.

### Uses

These fluoropolymer latex can be used in as a component in battery separator coatings to improve adhesion property.

The polymer of the present invention has applications as a component in in architectural coatings, in water purification membranes or in high purity piping for water supplies in the semiconductor industry.

### EXAMPLES

Examples are described below. The synthesis process and the fluoropolymer latex characterization are summarized below.

Light scattering test method for latex particle size: Nicomp CW380 Particle Size Analyzer (light scattering) is used to measure the particle size of the latex particles. The Volume Average particle size is used.

### Example 1-2. Preparation of Fluoropolymer Latex in a 2-Gallon Reactor

To a 2-gallon autoclave were added 4400 g of deionized water, PPGA, Poly(Propylene Glycol) Acrylate, Mn=475, n=7—available from Arkema Inc.) and/or SOS (sodium octylsulfonate). The autoclave was agitated at 72 rpm, heated to 83 C, and pressurized to 4475 kPa with vinylidene fluoride. An aqueous feed solution of 1.0 wt % KPS/1.0 wt % SAT was started at 240 g/h. Upon start of pressure drop, the KPS/SAT feed rate was adjusted so to maintain the pressure and the feed rate of VDF at approximately 500 g/hr (in the range of 5-20 g/h). The pressure was maintained by additional VDF feed. When the VDF feed amount reached 900 g, 23 g of ethyl acetate solution (8 wt % water solution) was fed at 1500 ml/h. After completing the ethyl acetate solution feed, The KPS/SAT rate is adjusted to maintain the pressure and the feed rate of VDF at approximately 500 g/hr. Feeds were continued in this fashion, until a total of 1900 g VDF had been fed to the reactor. The reaction temperature was maintained at 83 C for an additional 30 minutes. Then the pressure was allowed to autogenously decrease for 10 minutes at which point the reactor was vented to atmospheric pressure and cooled to room temperature. Product was discharged from the reactor.

TABLE 1

| | Surfactant name | | | Latex | Latex |
|---|---|---|---|---|---|
| | and amount | Ratio of | MV | solids | PS |
| Example | (ppm) | SCS/AGS | @100/s | (wt %) | (nm) |
| 1 | SOS 590 ppm + | 5.6 | 24 | 30.7 | 218 |
| | PPGA 105 ppm | | | | |
| 2 | SOS 550 ppm | 2.6 | 26 | 31.0 | 208 |
| | PPGA 210 ppm | | | | |

### Example 3. Preparation of Fluoropolymer Latex in a 80-Gallon Reactor

To an 80-gallon autoclave were added 166 kg of deionized water, 135.0 g SOS and 4.0 g PPGMA. The autoclave was agitated at 21 rpm, heated to 83C and pressurized to 4475 kPa with 3.2 kg of HFP and 15.5 kg of vinylidene fluoride. A feed of 2.0 wt % KPS/2.0 wt % SAT aqueous solution was started at 4.5 kg/h. Upon start of pressure drop, the KPS/SAT feed rate was reduced to 136 g/h and the pressure was maintained by additional VDF feed. A feed of 10.0 wt % PAA solution was started at 3.9 kg/h when VDF total reached 36.4 kg. Then the KPS/SAT feed rate was increased to 1.8 kg/h. Feeds were continued in this fashion, until a total of 72.7 kg of VDF had been fed to the reactor. The reaction temperature was maintained at 90C for additional 30 minutes. Then the pressure was allowed to autogenously decrease for 10 minutes at which point the reactor was vented to atmospheric pressure and cooled to room temperature. Product was discharged from the reactor.

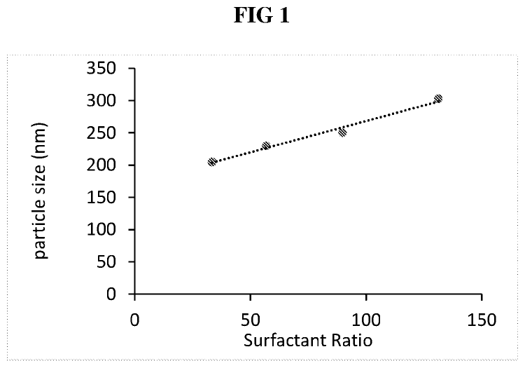

Example 4-6 were prepared in the same way as Example 3 but using the SOS and PPGMA amounts listed in Table 2. The amount of surfactant added in ppm is based on total fluoromonomer(s) added to the polymerization reaction. FIG. 1 is the graph of table 2, where the Surfactant ratio is SCS/AGS ratio.

TABLE 2
Latex particle size data from 80-gallon reactor

| | Sulfur containing | Acrylic-glycol | | |
|---|---|---|---|---|
| | surfactant | surfactant | Ratio of | Particle size |
| Example | (SCS)(ppm) | (AGS)(ppm) | SCS/AGS | (nm) |
| Example 3 | 1706 | 51 | 33.45 | 205 |
| Example 4 | 1706 | 30 | 56.87 | 230 |
| Example 5 | 1706 | 19 | 89.79 | 250 |
| Example 6 | 1706 | 13 | 131.23 | 303 |

These examples show that by varying the weight ratio of the two surfactants the particles size of the resulting polymer can be controlled. Decreasing acrylic-glycol surfactant results in an increased particle size.

1. A process for preparing a fluoropolymer said process comprising:
a) providing in a reaction vessel, an aqueous reaction medium, at least one fluoromonomer, optionally a chain transfer agent,
i) at least one acrylic-glycol surfactant having at least one segment selected from polyethylene glycol segment, polypropylene glycol segment, and/or polytetramethylene glycol segment, with from 2 to 200 repeating units in a segment, and
ii) at least one sulfur containing surfactant wherein the sulfur containing surfactant is non-fluorinated and comprises at least one of an alkylsulfonate, an alkyl sulfate surfactant, or mixtures thereof, and
b) adding at least one radical initiator to said reaction vessel,
c) initiating an emulsion polymerization of said fluoromonomer;
to provide a fluoropolymer latex,
wherein the total amount of surfactant(s) in the process is at least 110 ppm based on the total weight of the fluoromonomer(s) fed to the polymerization reaction.

2. The process of claim 1, wherein the weight ratio of the sulfur containing surfactant to the acrylic-glycol containing surfactant is between 0.1 and 500 (weight by weight).

3. (canceled)

4. The process of claim 1, wherein the amount of the sulfur containing surfactant in the process is from 100 ppm to less than 5000 ppm based on total fluoromonomer(s) fed to the emulsion polymerization reaction.

5. (canceled)

6. The process of claim 1, wherein the amount of the amount of the acrylic-glycol surfactant in the process is from about 10 ppm to about 1000 ppm based on total fluoromonomer(s) fed to the emulsion polymerization reaction.

7. (canceled)

8. The process of claim 1, wherein the volume average particle size of the fluoropolymer is in the range of 110 nm to 350 nm.

9. The process of claim 1, wherein the total amount of surfactant present in the process is at least 110 ppm and up to 6000 ppm, based on the total weight of the fluoromonomer(s) fed to the emulsion polymerization reaction.

10. (canceled)

11. (canceled)

12. The process of claim 1, wherein the acrylic-glycol containing surfactants are selected from the group consisting of, polyethylene glycol acrylate (PEGA), polyethylene glycol methacrylate (PEGMA), polypropylene glycol acrylate (PPGA), polypropylene glycol methacrylate (PPGMA), polypropylene glycol polyethylene glycol acrylate, polypropylene glycol polyethylene glycol methacrylate, and polypropylene glycol di-methacrylate.

13. The process of claim 1, wherein the surfactant(s) containing acrylic-glycol comprises polypropylene glycol methacrylate (PPGMA).

14. The process of claim 1, wherein alkyl group on the sulfur containing surfactant comprises a C6-C18 alkyl group.

15. The process of claim 1, wherein the sulfur containing surfactant comprises a non-fluorinated alkylsulfonate selected from the group consisting of octylsulfonates, octyldisulfonates, decylsulfonates, decyldisulfonates, dodecylsulfonates, dodecyldisulfonates, and combinations thereof.

16. The process of claim 1, wherein the sulfur containing surfactant comprises at least one of an octylsulfonate, an octyldisulfonate or a decylsulfonate.

17. The process of claim 1, wherein the sulfur containing surfactant comprises at least one of sodium lauryl sulfate, potassium lauryl sulfate, ammonium lauryl sulfate, lithium lauryl sulfate, sodium laureth sulfate, sodium octyl sulfate, potassium octyl sulfate, ammonium octyl sulfate, lithium octyl sulfate and combination thereof.

18. The process of claim 1, wherein the acrylic-glycol surfactant comprises polypropylene glycol methacrylate (PPGMA) and the sulfur containing surfactant comprises an octyl sulfonate.

19. The process of claim 1, wherein the radical initiator comprises a persulfate salt.

20. (canceled)

21. The process of claim 1, wherein at least 65 wt % of the fluoromonomer added comprises vinylidene fluoride monomer.

22. (canceled)

23. The process of claim 1, wherein said fluoropolymer is a vinylidene fluoride copolymer comprising at least one comonomer selected from the group consisting of tetrafluoroethylene, trifluoroethylene, hexafluoropropene, chlorotrifluoroethylene, vinyl fluoride, and combinations thereof.

24. (canceled)

25. An fluoropolymer latex composition comprising:
a) at least one sulfur containing surfactant and at least on acrylic-glycol surfactant and
b) at least one fluoropolymer.

26. The fluoropolymer latex composition of claim 25, wherein the acrylic-glycol surfactant is selected from the group consisting of, polyethylene glycol acrylate (PEGA), polyethylene glycol methacrylate (PEGMA), polypropylene glycol acrylate (PPGA), polypropylene glycol methacrylate (PPGMA), polypropylene glycol polyethylene glycol acrylate, polypropylene glycol polyethylene glycol methacrylate, and polypropylene glycol di-methacrylate, preferably polypropylene glycol methacrylate (PPGMA).

27. The fluoropolymer latex composition of claim 25, wherein the sulfur containing surfactant comprises a C6-C18 alkyl group.

28. (canceled)

29. The fluoropolymer latex composition of claim 25, wherein the acrylic-glycol surfactant comprises polypropylene glycol methacrylate (PPGMA) and the sulfur containing surfactant comprises an octyl sulfonate.

30. A fluoropolymer composition made by the process of claim 1.
